(19) United States
(12) Patent Application Publication
(10) Pub. No.: US 2007/0029250 A1
(43) Pub. Date: Feb. 8, 2007

(54) Filter device and method of manufacturing the filter device

(75) Inventors: Kenichiro Kimura, Obu-shi (JP); Kosaku Terada, Obu-shi (JP)

Correspondence Address: OLIFF & BERRIDGE, PLC, P.O. BOX 19928, ALEXANDRIA, VA, 22320, US

(73) Assignee: Aisan Kogyo Kabushiki Kaisha, Obu-shi (JP)

(21) Appl. No.: 11/476,688

(22) Filed: Jun. 29, 2006

(30) Foreign Application Priority Data
Aug. 2, 2005 (JP) 2005-223959

(51) Int. Cl. B01D 35/28

(52) U.S. Cl. 210/435; 210/446; 210/455; 210/445

(57) ABSTRACT

A fuel filter is provided with a filtering element and a resin case housing the element. The case includes a case body formed with upper and lower openings and covers closing the upper end lower openings. The case body is provided with a rib extending vertically therein. The upper and lower covers are welded to upper and lower end of the case body respectively. The element is welded, at upper and lower ends thereof, to the covers. Here, the element has a lateral end part bent in V-shape which is placed so as to overlap the rib. Upper and lower ends of the lateral end part together with upper and lower ends of the rib are welded to the upper and lower covers.

### BACKGROUND OF THE INVENTION

1. Field of the Invention

The present invention relates to a filter device for filtering out impurities in a fluid and, more particularly, to a filter device provided with an element housed in a case.

2. Description of Related Art

As a filter device of this type, heretofore, there has been a fuel filter disclosed in for example Japanese unexamined patent publication No. 11(1999)-082210. This fuel filter is structured such that a filtering member (an element) is fixed to a plate (a filter frame) with an adhesive. These filtering member and the plate are then welded by vibration. The filtering member and the plate are held by caulking.

In this fuel filter, however, the filtering member is fixed to a container through the plate, which results in an increase in the number of components by the plate. This is accordingly disadvantageous in manufacturing cost. The use of the plate also causes an increase in assembling process thereof, which is also inconvenient in working efficiency.

The applicant of the present invention has proposed a novel fuel filter in Japanese patent application No. 2004-4014 (filed on Jan. 9, 2004) and also a novel filter device in Japanese patent application No. 2004-181043 (filed on Jun. 18, 2004). In those fuel filter and filter device, a filtering material or member (element) itself is directly fixed to a filter case or a container to eliminate a conventionally used plate (filter frame). The latter filter device, particularly, includes a filter member, a resin container, and resin upper and lower covers which close the upper and lower ends of the container. The upper and lower covers are welded to the container housing the filter member so that the upper and lower ends of the filter member are embedded (stuck) in the upper and lower covers respectively. To be concrete, the upper and lower covers are partly melted, and the melted resin permeates the upper and lower ends of the filter member and cures or solidifies therein, thus fixing the filter member to the upper and lower covers.

In the above filter device, however, when the upper and lower ends of the filter member are embedded (stuck) in the upper and lower covers respectively, the upper and lower ends of each end portion of the filter member in a lateral direction (hereinafter, lateral end parts) may warp or become deformed due to resistance of the melted resin. If the upper and lower ends of each lateral end part warp or become deformed, such warped or deformed parts could only be embedded (stuck) slightly in the upper and lower covers, resulting in deterioration in weld or adhesion strength. Accordingly, reliability of the filter device may decrease.

### BRIEF SUMMARY OF THE INVENTION

The present invention has been made in view of the above circumstances and has an object to provide a filter device in which an element is directly fixed to a case to achieve a reduction in the number of components and the number of assembling processes and improve reliability of a finished product.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

To achieve the purpose of the invention, there is provided a filter device comprising a filtering element and a resin case housing the element, wherein the case includes a case body formed with upper and lower openings and covers closing the upper and lower openings, the case body is provided with a rib extending vertically therein, the covers are welded to upper and lower ends of the case body respectively, and the element is welded, at upper and lower ends thereof, to the covers, wherein the element has a lateral end part bent and placed to overlap the rib and bonded thereto, and upper and lower ends of the lateral end part together with upper and lower ends of the rib are welded to the covers.

According to another aspect, the present invention provides a method of manufacturing a filter device comprising a filtering element and a resin case housing the element, wherein the case includes a case body formed with upper and lower openings and covers closing the upper and lower openings, the case body is provided with a rib extending vertically therein, the method comprising the steps of: putting the element in the case body; bonding a lateral end part to the rib after disposing the lateral end part of the element to overlap the rib so that the lateral end part is in a bent form and upper and lower ends of the lateral end part overlap upper and lower ends of the rib; melting bottom walls of the covers and upper and lower ends of the case body; and putting the covers on the upper and lower ends of the case body respectively so that upper and lower ends of the element and the upper and lower ends of the rib are together embedded in melted resin generated in the bottom walls of the covers, and solidifying the melted resin generated in the covers and the case body to weld the covers to the element and to the case body respectively.

According to another aspect, the present invention provides a filter device comprising a filtering element and a resin case housing the element, wherein the case includes a case body formed with upper and lower openings and covers closing the upper and lower openings, the case body is provided with a rib extending vertically therein, the covers are welded to upper and lower ends of the case body respectively, and the element is welded, at upper and lower ends thereof, to the covers, wherein the element has a lateral end part bent and held in contact with and bonded to an inner wall of the case body so that a bend section of the lateral end part is held between a protruding end of the rib and the inner wall of the case body, and upper end lower ends of the lateral end part of the element together with upper and lower ends of the inner wall of the case body are welded to the covers.

According to another aspect, the present invention provides a method of manufacturing a filter device comprising a filtering element and a resin case housing the element, wherein the case includes a case body formed with upper and lower openings and covers closing the upper and lower openings, the case body is provided with a rib extending vertically therein, the method comprising the steps of: putting the element in the case body; bonding a lateral end part of the element to an inner wall of the case body after disposing the lateral end part in a bent form to overlap the inner wall so that a bend section of the lateral end part is held between a protruding end of the rib and the inner wall of the case body, and upper and lower ends of the lateral end part overlap upper and lower ends of the inner wall; melting bottom walls of the covers and upper and lower ends of the case body; and putting the covers on the upper and lower ends of the case body respectively so that upper and lower ends of the element and upper and lower ends of the case body are together embedded in melted resin generated in the bottom walls of the covers, and solidifying the melted resin generated in the covers and the case body to weld the covers to the element and to the case body respectively.

According to another aspect, the present invention provides a fuel supply apparatus comprising: a filter device mentioned above; a fuel tank for storing fuel; and a fuel pump for feeding under pressure the fuel from the fuel tank to the filter device, wherein the filter device, the fuel tank, and the fuel pump are assembled in modules.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is a sectional view of a fuel supply apparatus;

FIG. 2 is a plan view showing a schematic configuration of a fuel filter in a first embodiment, in a state where an upper cover is yet to be attached;

FIG. 3 is an enlarged plan view of part of the fuel filter of FIG. 2;

FIG. 4 is an enlarged plan view of part of the fuel filter of FIG. 2;

FIG. 5 is a sectional view taken along a line A-A of FIG. 2;

FIG. 6 is an explanatory view to explain an outline of a manufacturing process of the fuel filter;

FIG. 7 is an explanatory view showing a welding method applied to each lateral end part of an element;

FIG. 8 is a sectional view taken along a line B-B of FIG. 7;

FIG. 9 is a sectional view taken along a line C-C of FIG. 7;

FIG. 10 is a sectional view showing a state where a heating punch of FIG. 9 is moved;

FIG. 11 is an explanatory view showing a welding method for welding a case body and upper and lower covers;

FIG. 12 is an enlarged sectional view showing an upper peripheral portion of a case;

FIG. 13 is a plan view of a fuel filter in a second embodiment, in a state where an upper cover is yet to be attached;

FIG. 14 is an enlarged plan view of part of the fuel filter of FIG. 13;

FIG. 15 is an enlarged plan view of part of the fuel filter of FIG. 13; and

FIG. 16 is a sectional view taken along a line D-D of FIG. 13.

### DETAILED DESCRIPTION OF THE PREFERRED EMBODIMENTS

### First Embodiment

A detailed description of a first preferred embodiment of a filter device embodying the present invention will now be given referring to the accompanying drawings. In this embodiment, the filter device of the present invention and a fuel supply apparatus using the filter device will be explained.

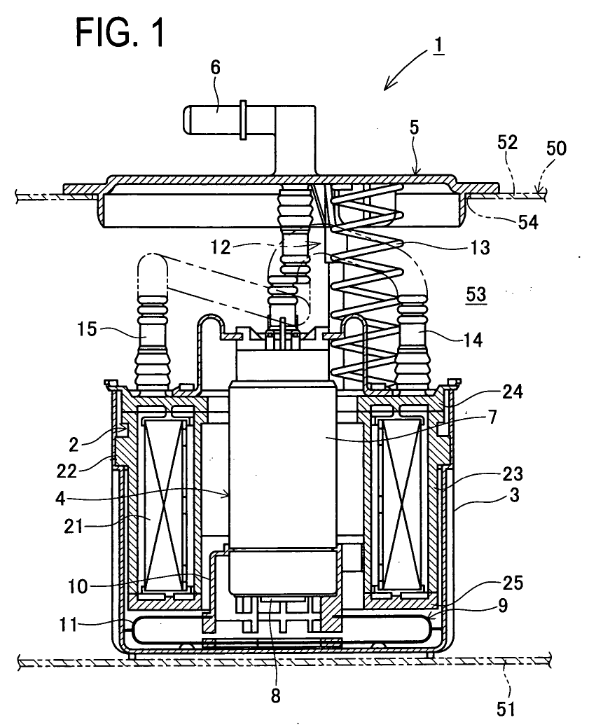

FIG. 1 shows a sectional view of a fuel supply apparatus 1. The fuel supply apparatus 1 is mounted in a fuel tank 50 which includes a bottom wall 51 and an upper wall 52, forming a fuel storing space 53 between both walls 51 and 52. The upper wall 52 is formed with an opening 54. The fuel supply apparatus 1 includes a fuel filter 2 corresponding to the filter device of the present invention, a reservoir cup 3, a fuel pump 4, a flange member 5, and others, which are assembled into modules. The fuel pump 4 is adapted to pressure feed the fuel stored in the fuel tank 50 to the filter device 2.

The reservoir cup 3 is of a substantially cup shape and placed on the bottom wall 51 of the fuel tank 50. The flange member 5 is fixed on the upper wall 52 to close the opening 54 thereof. A fuel discharge pipe 6 provided to the flange member 5 will be connected with a fuel supply pipe (not shown) through which fuel can be supplied to an engine.

The fuel pump 4 is an electrically-operated fuel pump, which is housed together with the fuel filter 2 in the reservoir cup 3. The fuel pump 4 includes a pump body 7 formed in substantially columnar shape. In the pump body 7, a pump part and an electrically-operated motor part (both being not shown) are incorporated. The pump body 7 has a suction port 8 at a lower end thereof and a discharge port (not shown) at an upper end thereof.

A suction filter 9 is mounted at a lower end portion of the pump body 7. This suction filter 9 includes an attachment member 10 fit on the lower end portion of the pump body 7, and a bag-like mesh 11 integral with the attachment member 10.

The fuel filter 2 is provided with a filtering element 21 and a resin case 22 housing the element 21. The case 22 has a case body 23 having upper and lower openings, and upper and lower resin covers 24 and 25 which close the upper and lower openings of the case body 23. The case body 23 is fixed to the upper and lower covers 24 and 25 by welding. These case body 23, upper cover 24, and lower cover 25 are made of polyacetal (POM).

The case 22 is fixed to the inside of the reservoir cup 3 with a fixing means such as a snap-fitting means. The mesh 11 of the suction filter 9 is placed under the case 22 so that the lower surface of the mesh 11 is positioned close to the bottom of the reservoir cup 3. The reservoir cup 3 and the flange member 5 are connected to each other through a connecting mechanism 12 having a well-known height-adjusting function. Between the reservoir cup 3 and the flange member 5, a spring 13 is interposed to resiliently press the reservoir cup 3 against the bottom wall 51 of the fuel tank 50.

The case 22 is formed with a fuel inlet port and a fuel outlet port not shown. The fuel inlet port is communicated with a discharge port of the fuel pump 4 through a pipe 14. The fuel outlet port is communicated with the fuel discharge pipe 6 of the flange member 5 through a pipe 15. Each of the pipes 14 and 15 is constituted of a flexible pipe or the like made of metal or resin formed in bellows shape. The fuel filter 2 is disposed on a high-pressure side with respect to the suction filter 9 and accordingly referred to as a high-pressure filter.

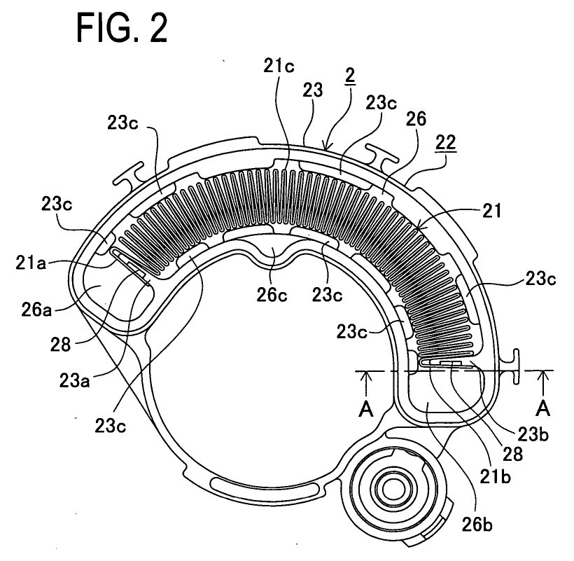

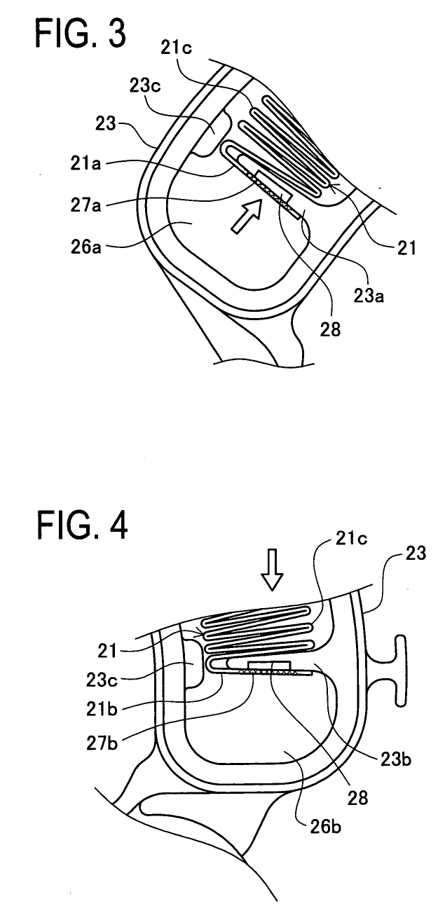

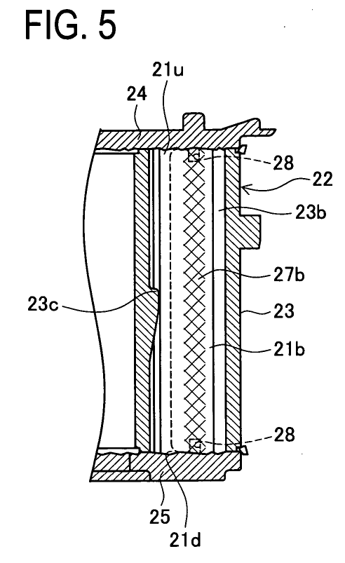

Here, the fuel filter 2 will be explained in detail below. FIG. 2 is a plan view of the fuel filter 2 to which the upper cover 24 has not yet been attached. FIGS. 3 and 4 are enlarged views of part of the fuel filter 2 of FIG. 2. FIG. 5 is a sectional view of the fuel filter 2 taken along a line A-A of FIG. 2. In this embodiment, the vertical direction and the lateral direction are defined relative to the orientation of the fuel supply apparatus 1 in FIG. 1. The lateral direction in FIG. 2 is regarded as the lateral direction of the fuel filter 2 and the vertical direction in FIG. 5 is regarded as the vertical direction of the fuel filter 2.

As shown in FIG. 2, the fuel filter 2 is of a substantially C-shaped (arc-shaped) form in plan view. The case body 23 includes an arc-shaped housing space 26. The case body 23 is internally formed with a first rib 23a and a second rib 23b provided in both end portions in the housing space 26 and extending in a vertical direction. The first rib 23a protrudes within the circular-arc housing space 26 from an inner-circumferential wall of the case body 23 to an outer-circumferential wall. Reversely, the second rib 23b protrudes within the circular-arc housing space 26 from the outer-circumferential wall to the inner-circumferential wall. The element 21 housed in the space 26 is formed in a folded shape having a plurality of pleats. The element 21 has lateral end parts 21a and 21b which are bent in V-shape, and placed overlapping the corresponding ribs 23a and 23b and welded thereto. In other words, the lateral end parts 21a and 21b of the element 21 are bent so as to straddle the ribs 23a and 23b respectively. Accordingly, the element 21 is fixed to the case body 23.

As shown in FIG. 2, a main part 21c of the element 21 other than the lateral end parts 21a and 21b is placed in the housing space 26 between the two ribs 23a and 23b. Both end areas of the housing space 26 are partitioned by the ribs 23a and 23b to provide a fuel inlet chamber 26a and a fuel reserve chamber 26b. The fuel inlet chamber 26a is in communication with the aforementioned fuel inlet port. At a center part of the housing space 26, a fuel outlet chamber 26c is provided protruding radially inwardly. The fuel outlet chamber 26c is in communication with the aforementioned fuel outlet port. The case body 23 is formed, on its inner wall, with a plurality of projections 23c for restricting deformation and movement of the main part 21c of the element 21 to ensure a fuel passage.

As shown in FIG. 3 as an enlarged view, the lateral end part 21a of the element 21 bent in V-shape to straddle the rib 23a defining the fuel inlet chamber 26a is welded to the first rib 23a. In FIG. 3, the part of the lateral end part 21a indicated by cross-hatching represents a welded portion 27a. The first rib 23a is formed, in its upper and lower parts, with grooves 28 mentioned later for the welded portion 27a. To this welded portion 27a, fuel pressure will act nearly vertically as indicated by a broad arrow. At this time, the lateral end part 21a of the element 21 bent as above will serve as a back board supporting the first rib 23a. This makes it possible to reduce a load of the fuel pressure on the welded portion 27a.

As shown in FIG. 4 as an enlarged view, on the other hand, the other lateral end part 21b of the element 21 bent in V-shape to straddle the second rib 23b defining the fuel reserve chamber 26b is welded to the rib 23b. In FIG. 4, the part of the lateral end part 21b indicated by cross-hatching represents a welded portion 27b. The second rib 23b is formed, in its upper and lower parts, with grooves 28 mentioned later for the welded portion 27b. This welded portion 27b is disposed on a side face of the second rib 23b opposite from a side on which fuel pressure will act as indicated by a broad arrow. At this time, similarly, the lateral end part 21b of the element 21 bent as above will serve as a back board supporting the second rib 23b. This makes it possible to reduce a load of the fuel pressure on the welded portion 27b.

As shown in FIG. 5, the upper and lower ends of the case body 23 are sealingly closed by the upper and lower covers 24 and 25 respectively. In the housing space 26 of the case body 23, an upper end 21u and a lower end 21d of the element 21 are fixed to the bottom walls of the upper and lower covers 24 and 25 by welding. Specifically, the lateral end parts 21a and 21b of the element 21 bent in V-shape are placed overlapping the ribs 23a and 23b and welded thereto, while the upper and lower ends 21u and 21d of each lateral end part 21a, 21b are welded, together with the upper and lower ends of each rib 23a, 23b, to the bottom walls of the upper and lower covers 24 and 25 respectively. Thus, the element 21 is directly fixed to the case 22 without the need of providing any additional component such as a filter frame.

Meanwhile, in the welded portion 27a, 27b between the lateral end part 21a, 21b of the element 21 and the rib 23a, 23b and the welded portion 27b of the lateral end part 21b to the rib 23b, flash or fins may be caused when excess melted resin is squeezed out from the welded portions 27a and 27b during a welding process and cured thereafter. If a product is finished with such flash or fins remaining unremoved, the flash or fins may partially come to be mixed to filtered fuel.

To avoid such defects, each of the ribs 23a and 23b of the case body 23 is formed, in respective upper and lower parts, with the grooves 28 in correspondence with upper and lower parts of each welded portion 27a, 27b in the vertical direction. Accordingly, excess melted resin is collected (received) in each groove 28 and cured as sticking therein. This cured resin is hard to come off the grooves 28. Thus, part of such cured resin will not be mixed to fuel.

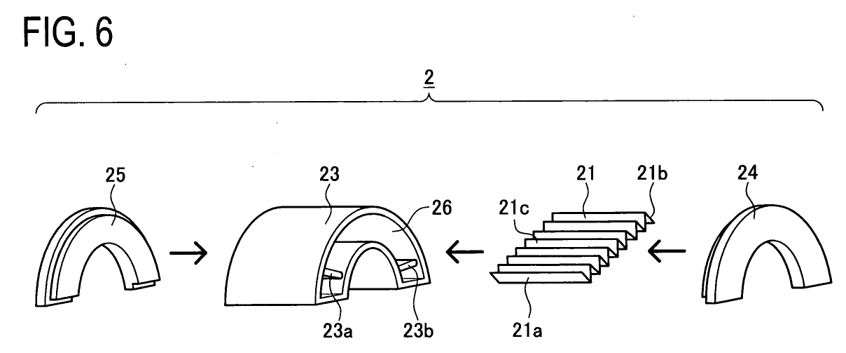

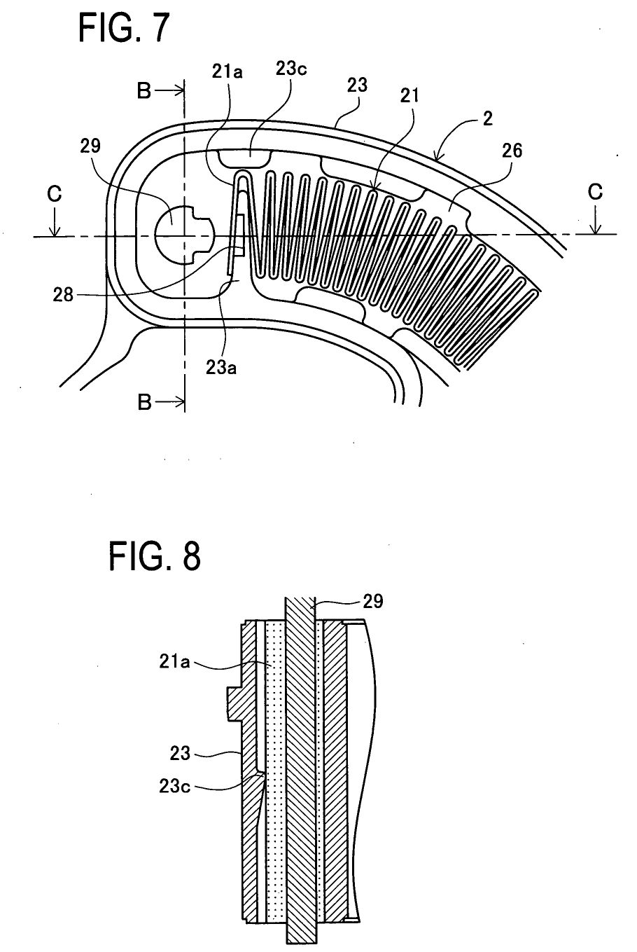

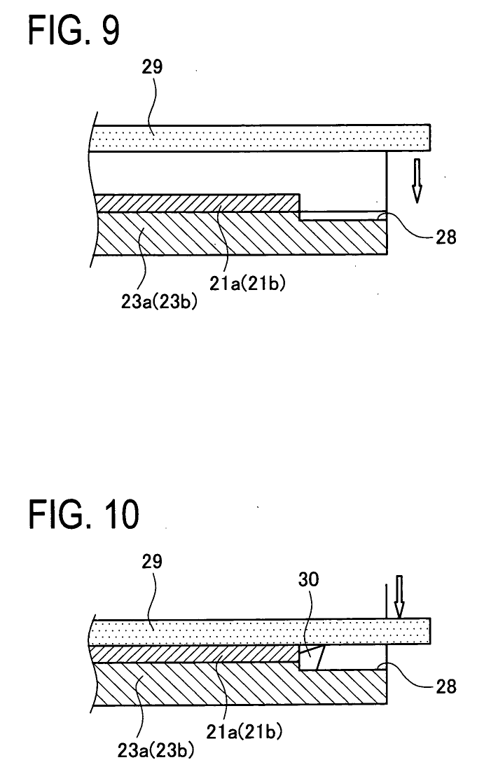

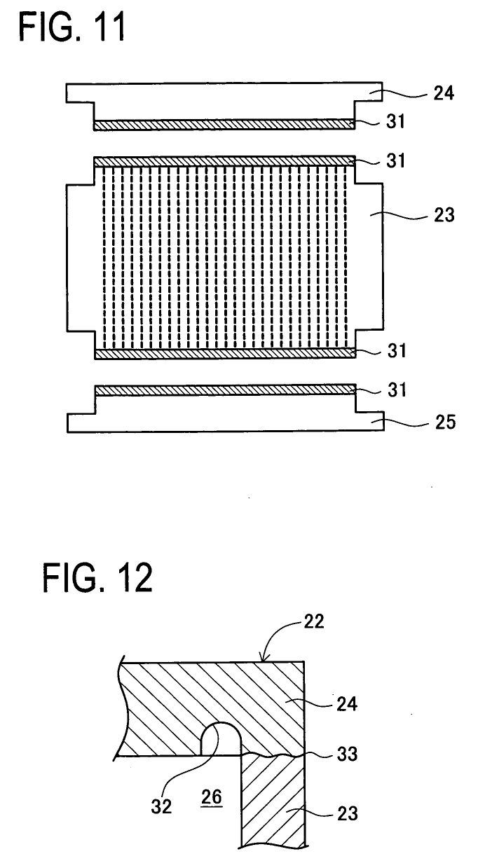

Here, a manufacturing method of the fuel filter 2 is explained below. FIG. 6 is an explanatory view to explain an outline of the manufacturing process of the fuel filter 2. FIG. 7 is an explanatory view showing a welding method applied to each of the lateral end parts 21a and 21b of the element 21. FIG. 8 is a sectional view taken along a line B-B of FIG. 7. FIG. 9 is a sectional view taken along a line C-C of FIG. 7. FIG. 10 is a sectional showing a state where a heating punch of FIG. 9 is moved into contact with the lateral end part(s) 21a or 21b. FIG. 11 is an explanatory view showing a welding method for welding the case body 23 to the upper and lower covers 24 and 25.

To manufacture the filter device 2, the following steps will be taken. In a first step, the element 21 is put in the housing space 26 of the case body 23 as shown in FIG. 6. At this time, the element 21 is disposed so that the main part 21c is placed in a space between the two ribs 23a and 23b and the lateral end parts 21a and 21b bent in V-shape are placed to overlap the ribs 23a and 23b respectively.

In a second step, the lateral end parts 21a and 21b of the element 21 bent in V-shape and placed overlapping the ribs 23a so that the upper and lower ends 21u and 21d of each lateral end part 21a, 21b overlap the upper end lower ends of each rib 23a, 23b are welded to the ribs 23a and 23b. This second step includes a step of melting the side faces of the ribs 23a and 23b, a step of allowing the melted resin generated in the side faces of the ribs 23a and 23b to permeate the lateral end parts 21a and 21b of the element 21 respectively, and a step of solidifying the permeated melted resin to fix the lateral end parts 21a and 21b to the ribs 23a and 23b.

Specifically, as shown in FIGS. 7 through 10, while the lateral end parts 21a and 21b of the element 21 are held in contact with the side faces of the ribs 23a and 23b, each contact portion is heated by a rod-like heating punch 29 previously heated. In other words, the heating punch 29 is moved in pressure contact with the side face of the rib 23a (23b) through the lateral end part 21a (21b) of the element 21 as shown in FIG. 10. At this time, the resin melted by heating permeates the lateral end part 21a (21b) of the element 21. After the melted resin has permeated sufficiently in the lateral end part 21a (21b), the heating punch 29 is separated from the rib 23a (23b). Then, the melted resin having permeated in the lateral end part 21a (21b) of the element 21 is allowed to cure by natural cooling. Each lateral end part 21a, 21b of the element 21 is thus firmly fixed to the case body 23. In other words, the side face of the rib 23a (23b) is heated and partly melted by the heating punch 29 and then solidifies after having permeated the lateral end part 21a (21b) of the element 21, thus fixing each lateral end part 21a, 21b to each rib 23a, 23b.

When the heated heating punch 29 is moved into contact with the side face of each rib 23a, 23b through the corresponding lateral end part 21a or 21b of the element 21 to melt the resin, excess melted resin is collected in the grooves 28 of each rib 23a, 23b. Thereafter, the collected melted-resin is cured into cured resin 30 in each groove 28. This makes it possible to prevent the resin from sticking to the heating punch 29 and enabling easy and reliable welding between the case body 23 and the upper and lower covers 24 and 25 in the next step.

In a third step, the bottom walls of the upper and lower covers 24 and 25 and the upper and lower ends of the case body 23 are melted respectively. Specifically, as illustrated with hatched lines in FIG. 11, the bottom walls of the upper and lower covers 24 and 25 and the upper and lower ends of the case body 23 are heated by a hot plate, melting them into melted resin 31.

In a fourth step, successively, the upper cover 24 and the lower cover 25 are disposed on and pressed against the upper and lower ends of the case body 23 respectively. At this time, the melted resin 31 permeates the upper end 21u and the lower end 21d of the element 21. While the upper end 21u and the lower end 21d of the element 21 and the upper and lower ends of each rib 23a, 23b are simultaneously embedded (stuck) in the corresponding melted resin 31 generated in the upper cover 24 and the lower cover 25, the melted resin 31 of the upper and lower covers 24 and 25 and the melted resin 31 of the case body 23 are allowed to solidify. In other words, the melted resin 31 is allowed to cure by natural cooling to weld the upper end 21u and the lower end 21d of the element 21 to the upper cover 24 and the lower cover 25 respectively, and simultaneously weld the upper cover 24 and the lower cover 25 to the case body 23. In short, the lateral end parts 21a and 21b of the element 21 are first integrally welded to the case body 23 and then the upper and lower covers 24 and 25 are welded to such integral structure to close the upper end lower openings of the case body 23. In this manner, the upper end 21u and the lower end 21d of the element 21 along with the upper end lower ends of each rib 23a, 23b are embedded (stuck) in the melted resin 31 generated in the upper cover 24 and the lower cover 25, and the melted resin 31 is allowed to solidify. This makes it possible to weld the upper cover 24 and the lower cover 25 to the element. 21 and nearly simultaneously to the case body 23.

Here, additional features of the case 22 will be described below. FIG. 12 is an enlarged sectional view of an upper peripheral portion of the case 22. As shown in FIG. 12, the bottom wall of the upper cover 24 welded to the upper end of the case body 23 is formed with a circumferential groove 32 facing to the inside of the case body 23, namely, the housing space 26. This circumferential groove 32 is formed continuously extending along a welded portion 33 between the upper end of the case 23 and the upper cover 24. The circumferential groove 32 serves to prevent fuel pressure in the housing space 26 from concentrating on the welded portion 33. The same structure applies to the lower cover 25 welded to the lower end of the case body 23.

In the fuel supply apparatus 1 in the present embodiment mentioned above, when the fuel pump 4 is activated, the fuel in the reservoir cup 3 is sucked through the suction filter 9 and fed under pressure into the fuel filter 2 through the discharge port (not shown) and the pipe 14. Then, the pressure-fed fuel passes through the element 21 in the fuel filter 2 while being filtered thereby. The thus filtered fuel is supplied to the engine via the pipe 15, the fuel discharge pipe 6 of the flange member 5, and the fuel supply pipe (not shown) in order.

According to the fuel filter 2 constituting the fuel supply apparatus 1, the upper cover 24 and the lower cover 25 are welded to the upper end and the lower end of the case body 23 respectively while the element 21 is housed in the housing space 26 of the case body 23. Thus, the case body 23 is closed. Simultaneously, the upper end 21u and the lower end 21d of the element 21 are directly fixed to the upper cover 24 and the lower cover 25 respectively. Therefore the element 21 can be directly fixed to the case 22 without needing a specific filter frame or the like. By the elimination of the specific filter frame or the like, it is possible to reduce the number of components and the number of assembling processes for the filter case 2.

According to the fuel filter 2, furthermore, the lateral end parts 21a and 21b of the element 21 are disposed in a bent form to overlap and welded to the corresponding ribs 23a and 23b respectively, while the upper end 21u and the lower end 21d of each lateral end part 21a, 21b are welded, along with the upper and lower ends of each rib 23a, 23b, to the upper cover 24 and the lower cover 25 respectively. The ribs 23a and 23b therefore serve as the back boards for supporting the bent lateral end parts 21a and 21b of the element 21, so that load of the fuel pressure on the welded portions 27a and 27b can be reduced. Because the lateral end parts 21a and 21b are bent and welded to the ribs 23a and 23b, the element 21 can have the strength against the fuel pressure. Further, the upper end 21u and the lower end 21d of each lateral end part 21a, 21b of the element 21 are embedded or stuck, along with the upper end lower ends of each rib 23a, 23b, in the upper cover 24 and the lower cover 25 respectively. Accordingly, the load on those upper end 21u and the lower end 21d can be relieved. Differently from the aforementioned conventional filter device, the upper end 21u and the lower end 21d of each lateral end part 21a, 21b of the element 21 can be prevented from warping or becoming deformed due to resistance of the melted resin 31 when the upper end 21u and the lower end 21d of the element 21 are embedded (stuck) into the upper cover 24 and the lower cover 25 respectively. Accordingly, the lateral end parts 21a and 21b can be stuck or embedded sufficiently in the melted resin 31. This will not cause a decrease in the welding strength. Consequently, the upper end 21u and the lower end 21d of the element 21 can be fixed entirely and firmly to the case 21. This makes it possible to improve reliability of the fuel filter 2 as a finished product.

In the present embodiment, since the lateral end parts 21a and 21b of the element 21 are bent in V-shape to overlap the corresponding ribs 23a and 23b, the lateral end parts 21a and 21b can be reinforced by the ribs 23a and 23b. It is accordingly possible to enhance durability and reliability of the lateral end parts 21a and 21b of the element 21 against the fuel pressure. In particular, the wended portion 27b of one lateral end part 21b of the element 21 to the second rib 23b is positioned on the side face of the second rib 23b opposite from the side face on which fuel pressure will act. Thus, the welded portion 27b can be preventing from becoming directly received the high fuel pressure. In this regard, durability and reliability of the lateral end part 21b can still further be enhanced.

According to the fuel filter 2, the lateral end parts 21a and 21b of the element 21 are welded to the side faces of the ribs 23a and 23b respectively. In other words, utilizing the melted resin generated in each rib 23a, 23b, each lateral end part 21a, 21b of the element 21 is welded to the side face of the corresponding rib 23a or 23b. No adhesive is additionally needed for such welding. In addition, utilizing the melted resin 31 generated in the upper and lower covers 24 and 25, the upper end 21u and the lower end 21d of the element 21 are welded to the corresponding covers 24 and 25 respectively without the need for additionally using an adhesive. In this regard, various materials to be used for manufacturing the filter device 2 can be reduced, achieving simplification of manufacturing control.

According to the fuel filter 2, the melted resin squeezed out of the welded portion 27a between the lateral end part 21a of the element 21 and the rib 23a and the welded portion 27b between the lateral end part 21b and the rib 23b is collected or received in each corresponding groove 28 and then solidifies therein. Thus, excess resin will not enter the housing space 26 of the case body 23. In this regard, the reliability of the fuel filter 2 can be enhanced. Since excess resin is collected in each groove 28, it is further possible to prevent the excess resin from adhering to the heating punch 29. This makes it possible to eliminate or reduce a work of removing the resin adhered to the heating punch 29, so that a manufacturing efficiency of the fuel filter 2 can be increased by just that much.

According to the fuel filter 2, as shown in FIG. 12, the upper cover 24 and the lower cover 25 welded to the upper end and the lower end of the case body 23 are formed with the circumferential grooves 32 in respective bottom walls. Accordingly, it is possible to prevent the fuel pressure in the housing space 26 from concentrating on the welded portions 33 between the case body 23 and each of the covers 24 and 25. In this regard, the durability and reliability of the fuel filter 2 can be enhanced.

### Second Embodiment

A second preferred embodiment of the filter device of the present invention will be described in detail below referring to accompanying drawings. Note that the same components or parts as those in the first embodiment are indicated by the same reference signs and their explanations are not repeated herein. The following explanation will be made focusing on different features from the first embodiment.

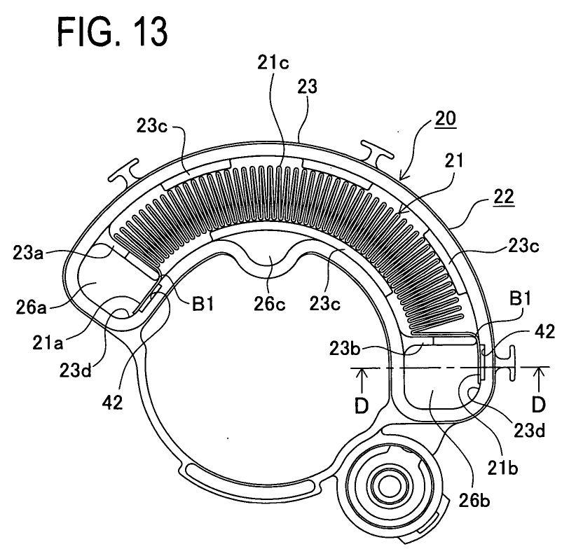

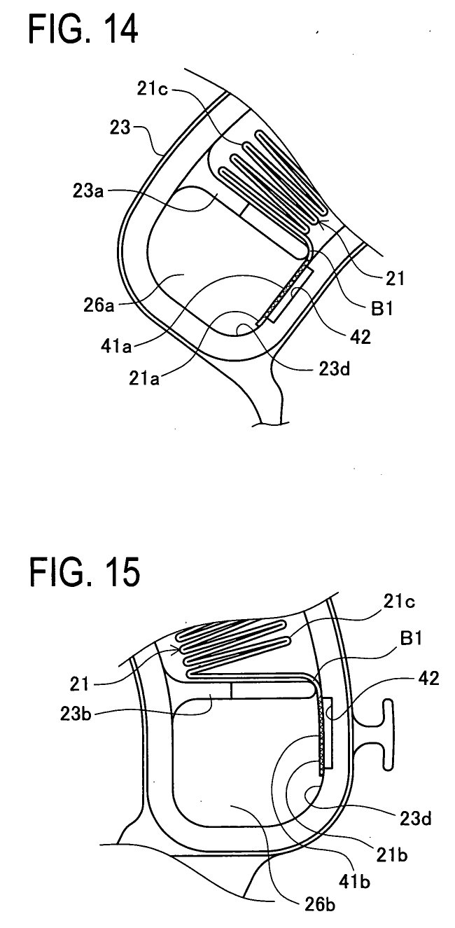

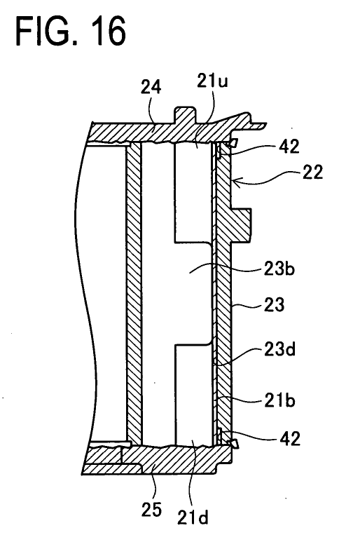

FIG. 13 is a plan view of a fuel filter 20 in a state where an upper cover 24 is yet to be attached. FIGS. 14 and 15 are enlarged plan views of part of the fuel filter of FIG. 13. FIG. 16 is a sectional view taken along a line D-D of FIG. 13. The fuel filter 20 in this embodiment differs from that in the first embodiment in how lateral end parts 21a and 21b of an element 21 are bonded to a case body 23.

In the present embodiment, specifically, the element 21 with the lateral end parts 21a and 21b bent in L-shape is bonded to an inner wall 23d of the case body 23 as shown in FIGS. 13 through 16. Further, each bend section B1 is held between a protruding end of each rib 23a, 23b and the inner wall 23d. In addition, an upper end 21u and a lower end 21d of each lateral end part 21a, 21b of the element 21 are welded, along with an upper end and a lower end of the inner wall 23d of the case body 23, to an upper cover 24 and a lower cover 25 respectively. The areas illustrated with hatched lines in FIGS. 14 and 15 represent welded portions 41a and 41b. For providing these welded portions 41a and 41b, the lateral end parts 21a and 21b of the element 21 are also welded to the inner wall 23d of the case body 23 in such a manner that melted resin generated in the inner wall 23d of the case body 23 when heated is allowed to permeate each lateral end part 21a, 21b and solidify therein.

In the inner wall 23d of the case body 23, grooves 42 are formed for receiving (collecting) the melted resin squeezed out of the welded portions 41a and 41b between the lateral end parts 21a and 21b of the element 21 and the inner wall 23d of the case body 23.

Note that each rib 23a, 23b is of a shape having a wider center portion than an upper portion and a lower portion in a vertical direction in FIG. 16. Accordingly, only the protruding ends of the center portions of the ribs 23a and 23b are held in contact with the corresponding bend sections B1 of the lateral end parts 21a and 21b of the element 21. A first rib 23a protrudes within a circular-arc housing space 26 from an outer-circumferential wall to an inner-circumferential wall. Reversely, a second rib 23b protrudes within the circular-arc housing space 26 from the inner-circumferential wall to the outer-circumferential wall.

In this embodiment, the fuel filter 20 will also be manufactured in the similar manner mentioned in the first embodiment. Specifically, in a first step, the element 21 is put in the case body 23. In a second step, the lateral end parts 21a and 21b of the element 21 are bent in L-shape. Respective bend sections B1 are held between the protruding ends of the corresponding ribs 23a and 23b and the inner wall 23d of the case body 23. The lateral end parts 21a and 21b are disposed on and welded to the inner wall 23d of the case body 23 so that the upper end 21u and the lower end 21d of each lateral end part 21a, 21b are placed to overlap the upper and lower ends of the inner wall 23d of the case body 23. This second step includes a step of melting the inner wall 23d of the case body 23 with a heating punch, a step of allowing the melted resin generated in the inner wall 23d of the case body 23 to permeate each lateral end part 21a, 21b of the element 21, and a step of solidifying the permeated melted resin to weld each lateral end part 21a, 21b to the inner wall 23d of the case body 23.

In a third step, successively, the bottom walls of the upper and the lower covers 24 and 25 and upper and lower ends of the case body 23 are melted by a hot plate respectively. In a fourth step, the upper cover 24 and the lower cover 25 are put on the upper end and the lower end of the case body 23 respectively. While the upper end 21u and the lower end 21d of the element 21 and the upper and lower ends of the case body 23 are simultaneously embedded (stuck) in the melted resin generated in the corresponding bottom walls of the upper and lower covers 24 and 25, the melted resin thereof solidifies. In this way, the upper and lower covers 24 and 25 are welded to the element 21 and also to the case body 23.

The fuel filter 20 in the present invention mentioned above can provide the same operations and effects as those obtained from the fuel filter 2 in the first embodiment. Specifically, according to the fuel filter 20, the upper cover 24 and the lower cover 25 are welded to the upper end and the lower end of the case body 23 housing therein the element 21, thus sealingly closing the case body 23. Simultaneously, the upper cover 24 and the lower cover 25 are directly fixed to the upper end 21u and the lower end 21d of the element 21 respectively. In this manner, the element 21 can be directly fixed to the case 22 without the need for using a specific filter frame or others. It is therefore possible to reduce the number of components and the number of assembling processes needed for the filter device 20 by the elimination of such filter frame or others.

According to the fuel filter 20, the element 21 is arranged such that the lateral end parts 21a and 21b are bent in L-shape and placed in contact with the inner wall 23d of the case body 23 and bonded thereto. Thus, respective bend sections B1 are held between the protruding ends of the ribs 23a and 23b and the inner wall 23d of the case body 23. Further, the upper end 21u and the lower end 21d of each lateral end part 21a, 21b of the element 21 are welded, along with the upper and lower ends of the inner wall 23d of the case body 23, to the upper cover 24 and the lower cover 25 respectively. Accordingly, the lateral end parts 21a and 21b of the element 21 are bent, and placed on and welded to the inner wall 23d of the case body 23, and respective bend sections B1 are held in cooperation with the protruding ends of the corresponding ribs 23a and 23b. Thus, the lateral end parts 21a and 21b of the element 21 can have a strength against the fuel pressure. The upper end 21u and the lower end 21d of each lateral end part 21a, 21b of the element 21 are embedded (stuck), along with the upper and lower ends of the inner wall 23d of the case body 23, in the upper cover 24 and the lower cover 25 respectively, which makes it possible to relieve the load on the upper end 21u and the lower end 21d. Differently from the aforementioned conventional filter device, the upper end 21u and the lower end 21d of each lateral end part 21a, 21b of the element 21 can be prevented from warping or becoming deformed due to resistance of the melted resin when the upper end 21u and the lower end 21d of the element 21 are embedded (stuck) into the upper cover 24 and the lower cover 25 respectively. Accordingly, the lateral end parts 21a and 21b can be embedded or stuck sufficiently in the melted resin. Thus, the welding strength will not decrease. Consequently, the upper end 21u and the lower end 21d of the element 21 can be fixed entirely and firmly to the case 21, which makes it possible to improve the reliability of the fuel filter 20 as a finished product.

In this embodiment, similarly, for the purpose of fixing the element 21 to the case body 23, the lateral end parts 21a and 21b of the element 21 are welded to the inner wall 23d of the case body 23 through the melted resin thereof. Thus, there is no need to additionally use an adhesive. In this regard, it is possible to reduce various materials used for manufacturing the filter device 20 and hence simplify manufacturing control.

In this embodiment, similarly, the melted resin squeezed out of the welded portions 41a and 41b between the lateral end parts 21a and 21b and the inner wall 23d of the case body 23 is collected (received) in the corresponding grooves 42 and solidifies therein. Accordingly, excess resin will not enter the housing space 26 of the case body 23. In this regard, the reliability of the fuel filter 20 can be enhanced. Since excess resin is collected in each groove 42, it is further possible to prevent the excess resin from adhering to the heating punch. This makes it possible to eliminate or reduce a work of removing the resin adhered to the heating punch, so that a manufacturing efficiency of the fuel filter 20 can be increased by just that much.

The present invention may be embodied in other specific forms without departing from the spirit or essential characteristics thereof. For instance, the following structures may be adapted.

In each of the above embodiments, the present invention is embodied as the filter device 2 or 20 of a substantially C-shaped (circular arc) form in plan view. Alternatively, the present invention may be embodied as a filter device of a nearly circular form in plan view or a filter device of a nearly I-shaped form in plan view.

In each of the above embodiments, the filter device of the present invention is embodied as the fuel filter 2 or 20. It may be embodied as a filter device adapted to remove impurities in various kinds of fluid other than fuel.

In each of the above embodiments, the lateral end parts 21a and 21b of the element 21 are fixed to the case body 23 by welding. Such fixing may be performed by using for example an adhesive and others.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. A filter device comprising a filtering element and a resin case housing the element, wherein the case includes a case body formed with upper and lower openings and covers closing the upper and lower openings, the case body is provided with a rib extending vertically therein, the covers are welded to upper and lower ends of the case body respectively, and the element is welded, at upper and lower ends thereof, to the covers,
wherein the element has a lateral end part bent and placed to overlap the rib and bonded thereto, and upper and lower ends of the lateral end part together with upper and lower ends of the rib are welded to the covers.

2. The filter device according to claim 1, wherein the lateral end part of the element is in a bent form to straddle the rib.

3. The filter device according to claim 1, wherein the lateral end part of the element is welded to the rib through resin forming a side face of the rib, the resin having been melted and allowed to permeate the lateral end part and solidify therein.

4. The filter device according to claim 2, wherein the lateral end part of the element is welded to the rib through resin forming a side face of the rib, the resin having been melted and allowed to permeate the lateral end part and solidify therein.

5. The filter device according to claim 3, wherein the rib is formed with a groove which receives the melted resin squeezed out of a welded portion between the lateral end part of the element and the side face of the rib.

6. The filter device according to claim 4, wherein the rib is formed with a groove which receives the melted resin squeezed out of a welded portion between the lateral end part of the element and the side face of the rib.

7. The filter device according to claim 1, wherein the upper and lower ends of the element are welded to the covers through resin forming a bottom wall of each cover, the resin having been melted and allowed to permeate each of the upper and lower ends of the element and solidify therein.

8. The filter device according to claim 2, wherein the upper and lower ends of the element are welded to the covers through resin forming a bottom wall of each cover, the resin having been melted and allowed to permeate each of the upper and lower ends of the element and solidify therein.

9. The filter device according to claim 3, wherein the upper and lower ends of the element are welded to the covers through resin forming a bottom wall of each cover, the resin having been melted and allowed to permeate each of the upper and lower ends of the element and solidify therein.

10. The filter device according to claim 4, wherein the upper and lower ends of the element are welded to the covers through resin forming a bottom wall of each cover, the resin having been melted and allowed to permeate each of the upper and lower ends of the element and solidify therein.

11. The filter device according to claim 5, wherein the upper and lower ends of the element are welded to the covers through resin forming a bottom wall of each cover, the resin having been melted and allowed to permeate each of the upper and lower ends of the element and solidify therein.

12. The filter device according to claim 6, wherein the upper and lower ends of the element are welded to the covers through resin forming a bottom wall of each cover, the resin having been melted and allowed to permeate each of the upper and lower ends of the element and solidify therein.

13. A method of manufacturing a filter device comprising a filtering element and a resin case housing the element, wherein the case includes a case body formed with upper and lower openings and covers closing the upper and lower openings, the case body is provided with a rib extending vertically therein, the method comprising the steps of:
putting the element in the case body;
bonding a lateral end part to the rib after disposing the lateral end part of the element to overlap the rib so that the lateral end part is in a bent form and upper and lower ends of the lateral end part overlap upper and lower ends of the rib;
melting bottom walls of the covers and upper and lower ends of the case body; and
putting the covers on the upper and lower ends of the case body respectively so that upper and lower ends of the element and the upper and lower ends of the rib are together embedded in melted resin generated in the bottom walls of the covers, and solidifying the melted resin generated in the covers and the case body to weld the covers to the element and to the case body respectively.

14. The manufacturing method of the filter device according to claim 13, wherein
the step of bonding the lateral end part of the element to the rib includes the steps of:
melting a side face of the rib;
allowing melted resin generated in the side face of the rib to permeate the lateral end part of the element; and
solidifying the permeated melted resin to weld the lateral end part of the element to the side face of the rib.

15. A filter device comprising a filtering element and a resin case housing the element, wherein the case includes a case body formed with upper and lower openings and covers closing the upper and lower openings, the case body is provided with a rib extending vertically therein, the covers are welded to upper and lower ends of the case body respectively, and the element is welded, at upper and lower ends thereof, to the covers,
wherein the element has a lateral end part bent and held in contact with and bonded to an inner wall of the case body so that a bend section of the lateral end part is held between a protruding end of the rib and the inner wall of the case body, and upper end lower ends of the lateral end part of the element together with upper and lower ends of the inner wall of the case body are welded to the covers.

16. The filter device according to claim 15, wherein the lateral end part of the element is welded to the inner wall of the case body through resin forming the inner wall of the case body, the resin having been melted and allowed to permeate the lateral end part and solidify therein.

17. The filter device according to claim 15, wherein the inner wall of the case body is formed with a groove which receives the melted resin squeezed out of a welded portion between the lateral end part of the element and the inner wall of the case body.

18. The filter device according to claim 16, wherein the inner wall of the case body is formed with a groove which receives the melted resin squeezed out of a welded portion between the lateral end part of the element and the inner wall of the case body.

19. A method of manufacturing a filter device comprising a filtering element and a resin case housing the element, wherein the case includes a case body formed with upper and lower openings and covers closing the upper and lower openings, the case body is provided with a rib extending vertically therein, the method comprising the steps of:
putting the element in the case body;
bonding a lateral end part of the element to an inner wall of the case body after disposing the lateral end part in a bent form to overlap the inner wall so that a bend section of the lateral end part is held between a protruding end of the rib and the inner wall of the case body, and upper and lower ends of the lateral end part overlap upper and lower ends of the inner wall;
melting bottom walls of the covers and upper and lower ends of the case body; and
putting the covers on the upper and lower ends of the case body respectively so that upper and lower ends of the element and upper and lower ends of the case body are together embedded in melted resin generated in the bottom walls of the covers, and solidifying the melted resin generated in the covers and the case body to weld the covers to the element and to the case body respectively.

20. The manufacturing method of the filter device according to claim 19, wherein
the step of bonding the lateral end part of the element to the inner wall of the case body includes the steps of:
melting the inner wall of the case body;
allowing melted resin generated in the inner wall of the case body to permeate the lateral end part of the element; and
solidifying the permeated melted resin to weld the lateral end part of the element to the inner wall of the case body.

21. A fuel supply apparatus comprising:
a filter device of claim 1;
a fuel tank for storing fuel; and
a fuel pump for feeding under pressure the fuel from the fuel tank to the filter device,
wherein the filter device, the fuel tank, and the fuel pump are assembled in modules.

22. A fuel supply apparatus comprising:
a filter device of claim 12;
a fuel tank for storing fuel; and
a fuel pump for feeding under pressure the fuel from the fuel tank to the filter device,
wherein the filter device, the fuel tank, and the fuel pump are assembled in modules.

23. A fuel supply apparatus comprising:
a filter device of claim 15;
a fuel tank for storing fuel; and
a fuel pump for feeding under pressure the fuel from the fuel tank to the filter device,
wherein the filter device, the fuel tank, and the fuel pump are assembled in modules.

24. A fuel supply apparatus comprising:
a filter device of claim 18;
a fuel tank for storing fuel; and
a fuel pump for feeding under pressure the fuel from the fuel tank to the filter device,
wherein the filter device, the fuel tank, and the fuel pump are assembled in modules.
